(19) United States
(12) Patent Application Publication
(10) Pub. No.: US 2010/0025965 A1
(43) Pub. Date: Feb. 4, 2010

(54) Ball Hitch Leg Guard

(76) Inventor: David Lee Caldwell, Mayfield, KY (US)

Correspondence Address: David Caldwell, 802 Weda Ave, Mayfield, KY, 42066, US

(21) Appl. No.: 12/181,322

(22) Filed: Jul. 29, 2008

(51) Int. Cl. B60D 1/60

(52) U.S. Cl. 280/507

(57) ABSTRACT

An automotive accessory, specifically a ball mount cover made from a compressible material that covers the ball mount, when the tongue is positioned in a chamber molded into the device; the devices does not interfere with the normal use of the trailer hitch and that minimizes injuries to knee, shin, and ankle from accidentally hitting or contacting the ball mount.

### BACKGROUND AND PRIOR ART

Although not new, the use of family vehicles to tow trailers has increased in popularity in recent decades. In part the increase can be attributed to an increase in variety of trailers to be towed, from small, more traditional “utility” trailer, livestock (mainly horses) trailers, and various camp trailers, to a variety of boat trailers, specialty trailers to transport land and snow vehicles, water craft, and trailers that serve as nearly complete, mobile shops for various crafts (plumbers, carpenters, painters, and electricians, for example). In addition an entire industry has emerged in the trailer rental business.

For purposes of the present invention, the trailer hitch, refers only to the male portion of the device that couples a tow vehicle to a trailer, and the male portion is structurally connected to the tow vehicle (although the connection may not be permanent). Disregarding special hitches associated with the fifth-wheel trailers (goose neck hitches) and hitched for which a segment of the rear bumper of the tow vehicle has been modified to receive/support the hitch ball element, the trailer hitch commonly comprises two major parts: a ball unit with which the female coupling element units to join the two vehicle and trailer, and the ball mount (also referred to as the hitch base, hitch frame, or drawbar mounting). The ball unit comprises the ball element, per se and a connecting stem or shank that connects the ball element to the ball mount.

The ball mount is connected by its proximal end to one or more structural elements of the tow vehicle and extends generally from the bottom of the rear bumper; generally it extends from about 12 to 24 inches (31 to 62 cm). Generally the ball mount is from 8 to 24 inches (19 to 61 cm) above ground level, most commonly 10 to 15 inches (25 to 38 cm).

The ball mount is commonly made of steel with the ball secured by a nut holding the threaded ball stem or shank in position when it traverses an opening in the ball hitch tongue. The opening is commonly from (0.5 top 2 inches) (1.3 to 5.0 cm) from the distil end of the ball mount.

Obviously, trailer hitches have increased the utility of many vehicles. Unfortunately, the ball, and particularly the ball mount constitutes a very real source of potentially painful and possibly serious injuries: injuries to the knees, shins, and ankles of those working with or around trailers when they inadvertently walk into or strike the ball mount as it protrudes from the rear of a vehicle below the general line of sight. Most accidents are painful blows to the shin area.

Preventing striking the ball tongue is not practical; however, a variety of devices have been suggested to reduce or minimize the severity of injury.

Numerous protective covers for trailer hitches have been described. Most include covering both the ball and the ball mount. Most also have multiple functions and are positioned on the hitch only when it is not in use, i.e. When a trailer is not attached to it. Use includes covering the “unsightly accessory” (trailer hitch), protecting the hitch (mostly from rusting), preventing contact with grease and/or dirt on the hitch, and reducing injuries from accidentally bumping the hitch (mostly by knees and shins).

U.S. Pat. No. 2,671,675 issued to Swaisgood on Jan. 7, 1950 recognizes the injury potential of the common trailer hitch. The '675 patent describes a trailer “hitch guard or cover” fabricated from aluminum or steel that is bolted to the hitch and fully encloses it when not in use. To reduce injuries the guard is rounded, without sharp edges or corners.

More recently, U.S. Pat. No. 4,955,968 issued Sep. 11, 1990 to Beckerer describes “a cover for a trailer hitch to prevent injury when the hitch is not in use.” The '968 patent claims a one-piece molded device that covers the ball and at least part of the ball mount and supports. In a continuation-in-part of the '968 patent application, (No. 258,648), a second patent (U.S. Pat. No. 5,037,122) issued to bickerer on Aug. 6, 1991 features, in contrast to the '968 patent, an oversized ball cover or dome to afford protection from accidental contact with the ball. Like the '968 patent, the device of the '122 patent is positioned only when the hitch is not in use, or must be removed for use.

U.S. Pat. No. 5,421,601 issued Jun. 6, 1995 to Hinze, describes a hinged, snap-on case-like device that encloses the ball and a portion of the ball mount.

U.S. Pat. No. 6,039,339 issued to Bello on Mar. 21, 2000, represents a marked difference from the art taught in the above-cited patents. The “Tow Ball and Shin Protector” of the '339 patent remains in position when the hitch is I use. The shank portion of the tow ball passes through a padded body and attaches normally to the ball mount. The device includes protruding, padded arms extend to the vehicle's body and exert pressure on it to stabilize the device and protectively cover of shield at least a portion of the ball mount and supporting elements of the hitch.

U.S. Pat. No. 6,412,8076B1 issued to Peacock on Jul. 2, 2002 describes a cushioned hitch cover that remains in position only when the hitch is not in use. The cover is split along a longitudinal top line for positioning around the ball and support structures: various closure means secure the split when the device is positioned on the hitch.

The major drawback to the '675, '968, '122, and '601 patents is seen in the fact that the device of each can be used only when the hitch is not in use. The device must be removed for use of the hitch and repositioned after each use. In addition, the device of the '675 and '601 patents are relatively large and cumbersome. Both are fabricated from hard material, thereby reducing the injury minimizing function.

Although the device of the '339 patent remains attached when the hitch is in use, the manner in which the device is attached and supported in position results in potentially unstable positioning and related potential loss of protective function. In addition, the device is positioned on the top of the ball mount with no protective covering of the underside or lower edges of the ball mount.

In addition to the foregoing patented devices, other devices designed to reduce injury from striking the ball or ball mount are available commercially. Most of the devices remain positioned while the hitch is in use. ARK Corporation (http://www.arkcorporation.com/html/shin_protectors.html) has marketed a rubber “shin protector that comprises a top deck that is secured to the ball mount by the ball shank passing through the device and through the ball mount and being secured as is common to the opposite side of the ball mount. The deck extends approximately an inch on either side of the ball mount and in a a curve, over the distil end of the ball mount. Heavy, rubber skirts are attached to the sides and rounded, distil end of the deck and descend vertically from it for a short distance. The skirts are fluted or deeply grooved to giving them a shock absorbing capacity when struck and thereby protecting against accidental, painful contact with the ball mount.

A modification of the ARK device, the rubber “Shin Absorber” has a top deck and an exterior, perimeter walls descending from the deck on both sides and from the curved, distil end. In addition the device has a partial bottom deck, extending a portion of the length of the top deck. The bottom deck is connected to the interior (bottom) surface of the top deck by opposing interior side walls, an interior, curved distil end wall that is parallel to the distil end of the top deck. The opposing interior, side walls and interior distil end wall are spaced uniformly, approximately 1 inch from the corresponding exterior walls. Short, rubber connector pieces attach the inner and exterior walls and serve as shock absorbers to contacts made along the side or distil end of the device. The interior side walls and corresponding section of the top deck and bottom deck describe a chamber. The top and bottom decks have directly opposing openings. The “Shin Absorber” is positioned on the ball mount by inserting the tongue into the chamber and securing it by passing the shank portion of the ball through the top deck, through the ball mount and through the bottom deck and securing the shank with a bolt. Inward pressure is on the exterior walls is absorbed by the connecting pieces, thereby reducing the chance of injury from accidental contact ball mount.

### SUMMARY OF THE INVENTION

A purpose of the invention is a cover device for the ball mount that affords protection from injury arising from accidental contact with the ball mount and that remains in positions when the hitch is in use.

A second purpose is a device that is adapted to varied sizes and shapes of ball mounts.

A further purpose of the invention is a device that is simple to install and that requires minimum maintenance.

And a still further purpose of the invention is an essentially solid device molded from resilient, shock absorbing material.

The invention can also be used to advertise business with logos attached and/or personalized by vinyl stickers pad/screen printed processes.

These and other purposes and goals are achieved by a ball hitch cover manufactured from a compressible material, such as, but not limited to, vinyl covered foam rubber. An insert chamber is molded into the material with a circular opening passing from the top, through the chamber, and through the bottom. By inserting the ball hitch cover onto the ball mount, inserting the ball shank through the top opening through the chamber to the bottom, such that securing the ball in place to the ball mount, the sides and distil end of the cover device form a solid, shock absorbing element covering the distil end and a part of the length of the sides of the ball the ball mount, and still further such that the ball hitch cover has a solid top and bottom; and that the material from which the device is fabricated resists damage from inadvertent contact with other vehicles or objects, resist damage from weathering and/or UV exposure and retains its resilience or compressibility when accidentally bumped or hit.

These and other features, aspects and advantages of the present invention will become understood and appreciated by reference to the following descriptions and examples, including the figures and appended claims.

### LIST OF FIGURES

FIG. 1 is a drawing showing the leg guard properly positioned on the ball mount.

FIG. 2A is a 3D image of the ball hitch leg guard of FIG. 1.

FIG. 2B is a cutaway diagram of the ball hitch leg guard.

FIG. 3A is a diagram of the ball hitch leg guard of FIG. 1.

FIG. 3B is a top view diagram of the ball hitch leg guard.

FIG. 3C is a diagram of the proximal end of the ball hitch leg guard.

### DESCRIPTIONS AND EXAMPLES

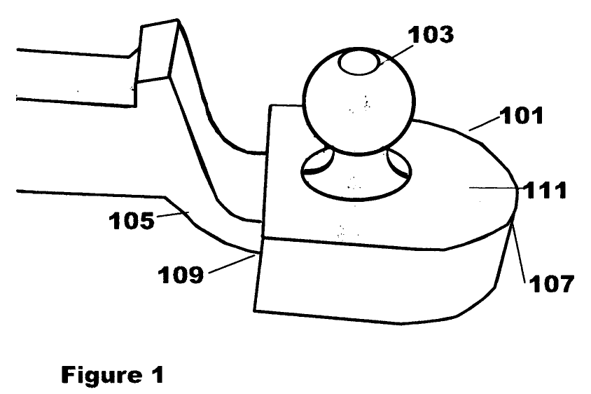

FIG. 1 illustrates the practical installation of the ball hitch leg guard 101 positioned with the ball mount 105 inserted into the chamber (not visible in this view), at the distil end 109, with a clear view of the curved proximal end 107 of the device. The ball element 103 is a properly positioned on the top deck 111 and secured by the shank passing through the top and bottom decks of the decks and enclosed ball mount 105 and being held in place by a nut on its distil end (not illustrated) It should be noted for all figures that the index numbers introduced in any figure for the various parts and features of the ball hitch leg guard are retained for the same part or feature in all subsequent figures.

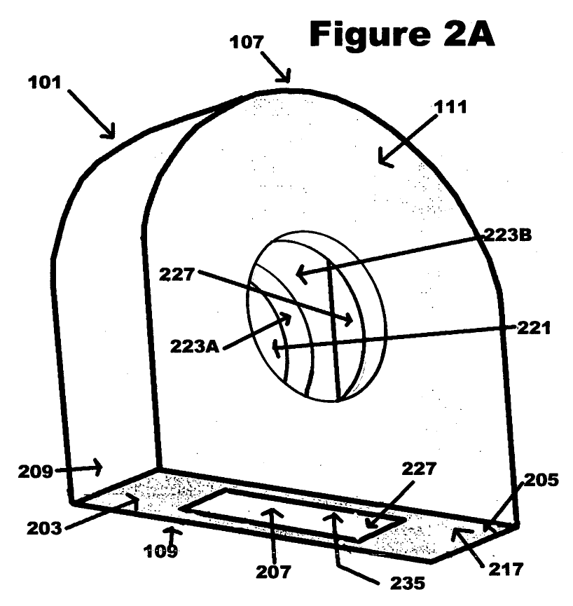

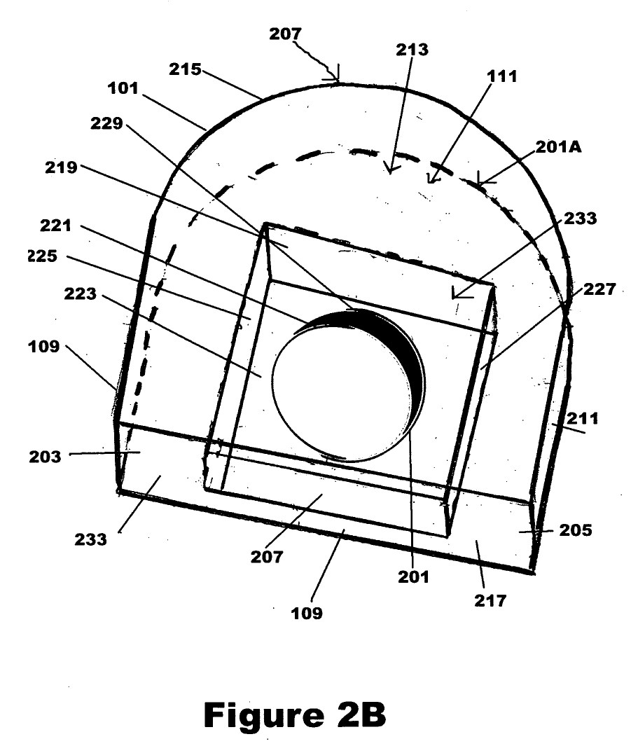

FIG. 2A is a sketch of the molded ball hitch leg guard of FIG. 1 and illustrates details of the ball hitch leg guard 101 suggested by FIG. 1, but not clearly visible in FIG. 1. The ball hitch leg guard illustrated is fabricated vinyl coated foam rubber. The resilience (or compressibility, a measure of softness or shock absorbance—a measure of ability to minimize injury from contact with the enclosed ball mount) is from 50-85% (with decreasing values indicating increasing hardness), preferably from 60-75%. Vinyl coated foam rubber and similar materials represent an advantage in addition to shock absorbing capacity;

they resist weathering and generally resist tearing from impact with hard objects (such as fixed objects or other vehicles) unlike rubber and similar materials. One skilled in the art recognizes that the invention includes other materials similar in physical properties to vinyl covered foam without altering the scope or purpose of the invention.

As illustrated in FIG. 2A, the ball hitch leg guard 101 is viewed from the top such that the opening 221 for the ball shank stem is seen from the top deck 111 through the bottom deck 223A with the upper surface 223B of the bottom being the floor of the chamber 235. The opening into the chamber 207 in the Proximal end 109 of the ball hitch leg guard reveals the chamber second wall 227, the first side wall 209, and proximal end wall 217 are readily identified. In addition the end face of the first 203 and the second 205 side shock absorber are shown. These shock absorbers (203 and 205) are vinyl covered foam rubber.

Referring to FIG. 2A and FIG. 2B, the first and second side shock absorbers 203 and 205 respectively and the distil end shock absorber 213 are defined as follows: the outer limit of the first side wall 209 and the first chamber wall 225 (for the first shock absorber 203), the second side wall 211 and the second chamber wall 227 (for the second shock absorber 205), and the distil end wall 225 and the distil camber wall 229 (for the distil end shock absorber 213).

It should be noted that the details of the chamber 235 interior suggested by FIG. 2A are clearly illustrated by the diagram of FIG. 2B in which a portion of the top click 111 to The right of line 201 A has been removed to reveal more clearly the chamber 235 and the first, second, and distil end chamber 225, 227 and 229 respectively, as well as the continuity of construction of the first side shock absorber, the second side absorber, and the distil end shock absorber 203, 205, and 213, respectively. The ball mount is positioned through the opening 207 in the chamber 235, and the shank element of the ball passes through the top deck, through the ball hitch shank, and through the bottom deck and is secured by a nut at its distil end, thereby securing the ball in position and securing the ball hitch leg guard in position such that the first side shock absorber, the second side shock absorber, and the distil end shock absorber effectively enclose the ball mount and provide a softy surface to minimize injuries in the event of accidental contact with the ball mount.

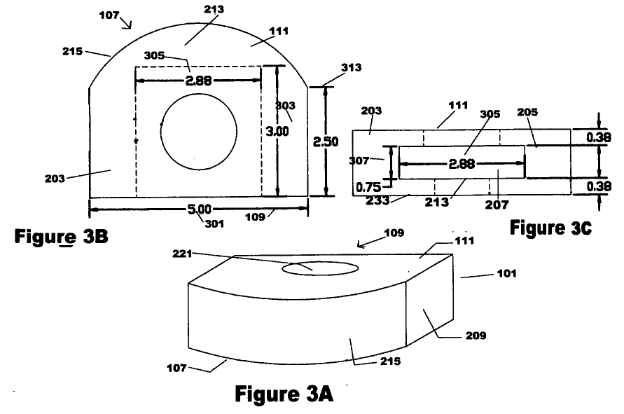

FIG. 3A provides a diagrammatic view of the ball hitch leg guard 101 showing the relationship of the distil end 107, proximal end 109, top deck 111, first side wall 109, first side wall 209, and distil end wall 215.

FIG. 3B provides examples, not limitations, of sizes of the various parts and areas of the ball hitch leg guard 111 as viewed from the top with the distil end 107 and proximal end 109 indicated and showing sample dimensions. Dimension illustrated include the width 301 of the proximal end (5 inches or 12.7 cm), depth 303 of the chamber (3 inches or 7.6 cm), and width 305 of the chamber 2.88 inches or 7.3 cm), The length of the first and the second side shock absorbers 203 and 205, respectively, is indicated by arrow 313 (2.5 inches or 6.3 cm). The width of the distil end shock absorber 213 is the same as the width of the proximal end 109. The length of the distil end wall 215 is a function of the radius of the arc describing the wall and is variable.

FIG. 3C illustrates details of the proximal end 109 of the ball hitch leg guard indicating the top deck 111 and the bottom deck 233, height 307 and width 305 of the opening 207 of the chamber 207 and floor of the chamber 22, as well as the thickness 311 of the top and bottom decks 111 and 233 respectively (0.75 inch or 1.3 cm).

It is obvious to one of average skill in the art that the above dimensions are illustrative and not limitations on the scope or purpose of the invention. Any of all dimensions may change as a function of the particular size of the shape of the ball mount and such variations are anticipated by the invention and appended claims. None the less, a ball hitch guard of any specific dimensions may be used effectively with any dimensions ball mount into which the tongue element can be positioned in the chamber and the shank inserted to secure the ball and the ball hitch leg guard. It also should be clear that the top and bottom decks can be reversed with affecting the purpose or scope of the invention. An exception to this reversal is the case in which the opening in the upper deck for the ball shank has been slightly enlarged for part of its depth on the upper surface, but not entirely though the top deck to accommodate design features at the top of the ball shank/base of the ball unit. This minor modification does not affect the scope or purpose of the invention and is anticipated by the invention.

What I claim is:

1. A device to minimize painful injuries resulting from accidentally striking the ball mount of a trailer hitch, said device being fabricated from vinyl covered foam rubber and molded into a one piece unit with no movable parts, with a circular opening through the unit to receive the ball and a rectangular cavity located on the flat end of the unit to receive the ball mount.

2. The device of claim 1 wherein said material is vinyl covered foam rubber.
